(19) United States
(12) Patent Application Publication
(10) Pub. No.: US 2004/0080795 A1
(43) Pub. Date: Apr. 29, 2004

(54) Apparatus and method for image capture device assisted scanning

(76) Inventors: Heather N. Bean, Fort Collins, CO (US); Mark N. Robins, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/278,371

(22) Filed: Oct. 23, 2002

(51) Int. Cl. H04N 1/48; H04N 1/04; H04N 1/40

(52) U.S. Cl. 358/505; 358/509; 358/453; 358/538; 358/474

(57) ABSTRACT

The present invention provides a system and method for scanning selected portions of a document. Briefly described, in architecture, one embodiment projects a beam of light onto a document portion, detects reflected light from the document portion with an image capture device, and determines a location of the document portion on the document based upon information received from the image capture device.

### TECHNICAL FIELD

The present invention is generally related to scanning documents, more particularly, is related to a system and method for scanning selected portions of a document.

### BACKGROUND

Scanning devices are configured to scan a document such that an electronic copy of the document is generated. The electronic document copy may be stored in a suitable media, such as a memory, compact disk, magnetic tape, etc. As the document is required at a later date, the electronic document copy can be retrieved, examined, printed and/or further processed.

Often, a document group having multiple documents is scanned. Such documents may be part of a larger work. Also, many documents and/or document groups may be scanned in a serial fashion such that the scanning process is quite time consuming. In such applications, automated scanning systems include a document transport handling system so that documents are serially passed into the scanning device for scanning. Thus, a large plurality of batch jobs can be more quickly processed.

Furthermore, it may be desirable to identify portions of a document to be scanned such that selected document portions are scanned and remaining portions are not scanned. Such a scanning process conserves memory resources. However, scanning selected document portions requires human interface such that a human operator determines desirable document portions and specifies the selected document portions to the scanning device. Device interfaces are known to facilitate the speed and convenience at which a human operator selects document portions of interest for scanning. For example, the document may be pre-scanned and displayed on a display so that the operator may use a mouse device or the like to select document portions of interest via the display. Manually selecting document portions by a human operator is still a time consuming effort since pre-scanning requires time. Also, requiring the operator to use a mouse device to select document portions of interest via the display is a relatively unnatural process (as compared to pointing with a finger). Furthermore, when many documents are serially scanned, selecting many document portions of interest requires a significant amount of time.

### SUMMARY OF THE INVENTION

The present invention provides a system and method for conserving resources when images are printed. Briefly described, in architecture, one embodiment projects a beam of light onto a document portion, detects reflected light from the document portion with an image capture device, and determines a location of the document portion on the document based upon information received from the image capture device.

### BRIEF DESCRIPTION OF THE DRAWINGS

The components in the drawings are not necessarily to scale relative to each other. Like reference numerals designate corresponding parts throughout the several views.

FIG. 1 is a diagram illustrating an automated document scanning system embodiment according to an embodiment of the present invention.

FIG. 2 is an illustration of a view of portions of the document, identified by shining light beam generated by the light pen, that are to be scanned by an embodiment of the present invention.

FIG. 3 is a diagram illustrating an embodiment of an operator input device.

FIG. 4 a diagram illustrating another embodiment of an automated document scanning system.

FIG. 5 is a flowchart illustrating an embodiment of a process for determining and communicating location information of a document portion to a scanning device.

FIG. 6 is a flowchart illustrating another embodiment of a process for determining and communicating location information and characteristics of a document portion to a scanning device.

FIG. 7 is a diagram illustrating an alternative embodiment of an operator input device.

### DETAILED DESCRIPTION

The present invention provides a system and method for scanning selected portions of a document. More specifically, in one embodiment, the location and/or characteristics of selected portions of a document are identified using light generated by a light pen or the like that is detected by an image capture device.

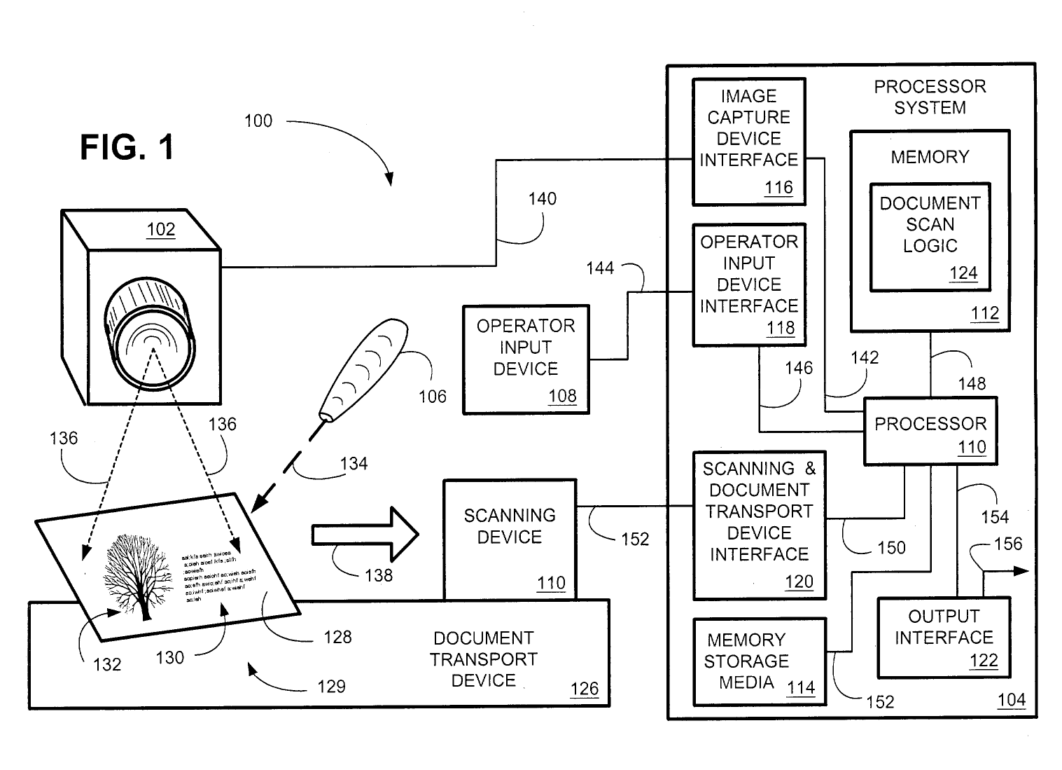

FIG. 1 is a diagram illustrating an automated document scanning system 100 according to an embodiment of the present invention. The automated document scanning system 100 includes an image capture device 102, a processor system 104, a light pen 106, operator input device 108 and a scanning device 110. Processor system 104 further includes processor 111, memory 112, memory storage media 114, image capture device interface 116, operator input device interface 118, scanning and document transport device interface 120 and output interface 122. Document scan logic 124, residing in memory 112, is retrieved and executed by processor 111. Scanned document portions, generated in accordance with the present invention, are stored in/by memory storage media 114. Associated with scanning device 110 is the document transport device 126. Document transport device 126 is configured to serially transport a plurality of documents for scanning in accordance with the present invention. Image capture device 102 may be any suitable digital image capture device, such as a digital still or video camera, so long as the image capture device 102 is configured to communicate with processor system 104 and is configured to capture images of the document 128 as described herein.

In the above-described embodiment of the automated document scanning system 100, a document 128 is laying on a region 129 of the document transport device 126 that is viewable by an operator (not shown) of the automated document scanning system 100. As described in greater detail herein, the operator, using light pen 106, specifies the location of portions of document 128 for scanning by shining a light beam 134 onto the portions of the document that are to be scanned. In one embodiment, light color identifies the characteristic of the document portion.

The document 128 is a simplified illustrative example having a text region 130 (comprised of text) and an image region 132 (having an image). Thus, the text region 130 is generally characterized as text and the image region 132 is generally characterized as an image. Image capture device 102 detects reflections of the light beam 134 from the document 128 and provides the information to processor system 104. Accordingly, image capture device 102 is positioned generally above document 128 so that document 128 is visible to image capture device 102, as indicated by the image capture device 102 viewing region represented by dashed lines 136. Processor system 104 associates the portions of the document, identified by detected reflections from the document 128 caused by light beam 134, such that when document 128 is later scanned by scanning device 110, only the selected portions of the document 128 are scanned (or saved, depending upon the embodiment).

When the operator has completed selection of document portions for scanning, a suitable signal is provided from the operator input device 108 to indicate that processing of the current document 128 is completed. The document transport device 126 then communicates the document 128, generally in the direction indicated by arrow 138, into position for scanning by the scanning device 110.

Furthermore, if another document is to be processed by the operator, such as in a batch job having a plurality of documents, the document transport device 126 communicates the next document to the work area viewable by the operator. Also, if there is another document that was being previously scanned by scanning device 110, the document transport device 126 moves that previous document (after completion of scanning) to a suitable repository (not shown) so that the previous document can be later retrieved, thereby clearing the path for document 128 to be communicated into position for scanning by scanning device 110.

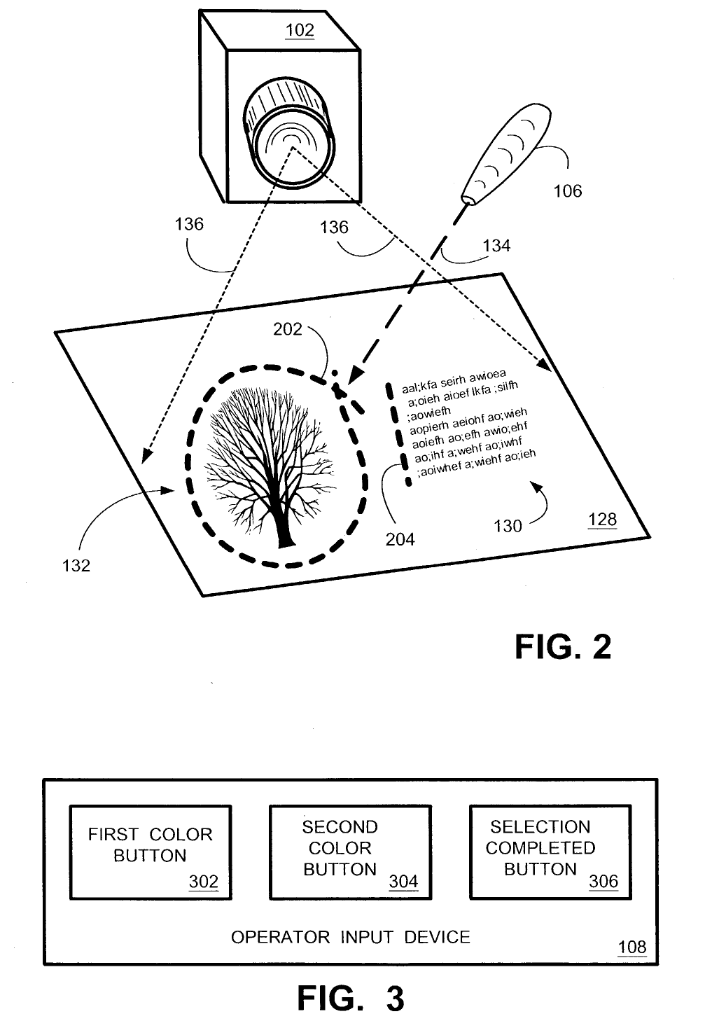

FIG. 2 is an illustration of a view of portions of document 128, identified by shining light beam 134 generated by light pen 106, that are to be scanned by the present invention. With respect to image region 132 (having an image of a tree illustrated for convenience), one embodiment identifies the location (and the extent) of the image region 132 by having the operator “draw” a circle (or the like) around the image region 132. That is, the operator shines the light beam 106 in a generally circular path 202 around the image region 132. Image capture device 102, by detecting reflected light from the document 128, provides information to processor system 104 (FIG. 1) such that the location and/or characteristics of a document portion, such as image region 132, is identifiable by the scanning device 110 (FIG. 1) when document 128 is scanned. In another embodiment, location information is used to identify the document portion after document 128 is scanned.

In one embodiment, image region 132 is characterized as an image that is to be scanned using a relatively high resolution because the image in the image region 132 is considered as being of sufficient interest to be scanned in detail at high resolution. For example, the image region 132 may contain a photograph, detailed drawing or the like.

To identify image region 132 as being scanned at a higher resolution, one embodiment employs a predefined light color for light beam 134. Thus, when image capture device 102 detects reflected light of the predefined color, processor system 104 (FIG. 1) recognizes that the identified portion of document 128 has an image that is to be scanned and/or processed using high resolution.

The above-described embodiment identifies the location (and extent of) an image region that is to be scanned using high resolution by determining the region defined by the light beam path 202. In another embodiment, the image region is defined by shining light beam 134 on a portion of the object of interest (rather than drawing a circle around the image). With this embodiment, document scan logic 124 (FIG. 1) includes logic to identify boundaries of the object of interest such that an image region 132 is defined for scanning.

With respect to text region 130, one embodiment characterizes the text region 130, and then determines the location of the text region 130, by having the operator “draw” a line adjacent to and in close proximity to the text region 130. That is, the operator shines the light beam 134 in a generally straight line path 204 next to the left side of text region 130. Image capture device 102, by detecting reflected light from the document 128, provides information to processor system 104 (FIG. 1) such that the location of (and extent of) the text region 130 is identifiable by the scanning device 110 (FIG. 1) when document 128 is scanned.

In one embodiment, text region 130 is characterized as a portion of document 128 that is to be scanned and/or processed using suitable resolution such that scanned text can be determined with an optical character resolution (OCR) system. Accordingly, data corresponding to the determined string of text characters is stored, thereby reducing memory capacity used to store information corresponding and contained in the text region 130 (as compared to memory capacity that would otherwise be used if text region 130 was stored as an image).

To identify text region 130 as being scanned at a resolution suitable for an OCR system, one embodiment employs a second predefined light color for light beam 134. Thus, when image capture device 102 detects reflected light of the second predefined color, processor system recognizes that the identified portion of document 128 is text that is to be scanned and/or processed at a resolution suitable for an OCR system.

The above-described embodiment identifies as an image region that is to be scanned and/or processed using a resolution suitable for an OCR system by determining the region defined by the light beam path 202 that is shined to the left of the text region 130. In another embodiment, the text region 130 is defined by shining light beam 134 to the right of text region 130 (rather than to the left of text region 130). With another embodiment, the text region 130 is identified when the operator shines light beam 134 along and/or over lines of text that are to be scanned. In yet another embodiment, the text region 130 is defined by encircling the text region 130 (similar to light beam path 202). Another embodiment identifies a line of text when the light beam is shined on a portion of the line of text (document scan logic 124 of FIG. 1 includes logic to identify boundaries of the line of text). It is understood that identifying a text region 130 can be done in any variety of manners by various embodiments of the invention. Furthermore, a plurality of manners may be used to identify a text region 130.

Returning to FIG. 1, it is appreciated that the illustrated embodiment provides a convenient, quick and natural way for an operator to select portions of document 128 for scanning. When many documents and/or document groups are serially processed, the document transport device 126 is configured to manage communication of the documents from a source (not shown), to a location viewable by the operator, then to the scanning device, and finally to a receptacle for later retrieval. Thus, it is very convenient for the operator since the operator does not need to handle the documents. Also, the document transport device 126 more quickly communicates the documents through the selection and scanning processes. The process of identifying document portions for scanning is natural in that the operator points the light pen 106 to the portions of the document 128 that are to be scanned (rather than using a more complex interface mechanism such as a mouse and a display that displays a pre-scanned document).

Accordingly, in the embodiment of FIG. 1, image capture device 102 communicates information corresponding to images of document 128, having detected reflections from the colored light beam 134, to processor system 104, via the image capture device interface 116 and connections 140/142. Furthermore, the communicated information is streamed or periodically communicated such that the path of light beam 134 as it travels over the surface of document 128 is determinable.

The image of document 128 detected by image capture device 102 is further processed to define document page edges, reference positions and/or boundaries. Thus, the document scan logic is configured to recognize page edges of document 128 so that location information identifying location of a document portion can be determined. Any suitable page recognition algorithm may be used by the present invention. For example, but not limited to, a change in color between a background that the document 128 is laying on and the document 128 may be detected to define a page edge and/or document boundary. In another embodiment, at least one reference mark exists on the document 128 that is detected by image capture device 102. Accordingly, the relative position of the portions of document 128 identified by the user with the light beam 134 is determinable so that when the document 128 is later scanned using scanning device 110, the identified portions of document 128 can be determined on the scanned document.

In one embodiment, a plurality of captured images are compiled such that the path of light beam 134 travelling over document 128 is determined. That is, a series of images received from the image capture device 102 are analyzed to determine the path of light beam 134. As image data is received from the scanning device 110 when document 128 is scanned, the scanned image and a composite image having the determined path of light beam 134 are overlaid with each other to determine the identified portion of document 128. In another embodiment, the path of the light beam 134 travelling over document 128 is determined using a suitable coordinate system. Thus, the identified portion of the scanned document 128 is determinable from the determined coordinates.

The operator may optionally communicate the start or end of document processing (and/or the start or end of a document group) using the operator input device 108, described in greater detail below. When actuated, operator input device 108 generates and communicates a signal via the operator input device interface 118 and connections 144/146, to processor system 104. Thus, processor system 104 communicates a signal (or information) indicating that the operator is done selecting portions of document 128 for scanning. Accordingly, document transport device 126 would understand that it is time to communicate document 128 to scanning device 110.

Once the document transport device 126 has positioned document 128 for scanning by scanning device 110, the selected portions of document 128 are scanned. In another embodiment, the entire document 128 is scanned, and data corresponding to the selected document portions are determined and communicated to a memory for saving. This determination may be made by the scanning device 110 or the processor system 104, depending upon the embodiment. Thus, in one embodiment, information corresponding to the scanned selected portions of document 128 is communicated back to processor system 104 and is stored in the memory storage media 114, via connection 152. The information corresponding to the scanned document portions may later be retrieved at a convenient time and communicated to another device, via output interface 122 and connections 154/156. For example, but not limited to, the retrieved selected scanned portions of document 128 may be communicated to a printing device for printing.

For convenience, memory 112 and memory storage media 114 were illustrated and described as separate components. In one embodiment, memory 112 and memory storage media 114 are selected and configured to store the document scan logic 124 and scanned information, respectively. Thus, different memory media are selected so as to more efficiently store the document scan logic 124 and scanned information, respectively. In another embodiment, memory 112 and memory storage media 114 are a single component configured to store both the document scan logic 124 and scanned information. In yet another embodiment, memory storage media 114 is not included as an element of processor system 104. Rather, scanned information is communicated from the processor system 104, via output interface 122 and connections 154/156, to a designated information storage device. In another embodiment, memory storage media 114 resides in the scanning device 110.

Memory 112 and memory storage media 114 are computer-readable medium that is an electronic, magnetic, optical, or other another physical device or means that contains or stores data, a computer program, and/or a processor program. In the context of this specification, a “computer-readable medium” can be any means that can store, communicate, propagate, or transport the program associated with document scan logic 124 for use by or in connection with the instruction execution system, apparatus, and/or device. The computer-readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium, could even be paper or another suitable medium upon which the program associated with the data, the computer program, and/or the processor program is printed, since they can be electronically captured, via for instance optical scanning of the paper or other medium, then compiled, interpreted or otherwise processed in a suitable manner if necessary, and then stored in memory 112 and/or memory storage media 114.

For convenience, connections 140, 144, 152 and 156 were illustrated as hardwire connections. Any one of the connections 140, 144, 152 and/or 156 may be implemented with other suitable media, such as infrared, optical, wireless or the like without departing from the present invention. Furthermore, connections 142, 146, 148, 150, 152 and 154 were illustrated for convenience as hard wire connections to processor 111. In other embodiments, one or more of these connections 142, 146, 148, 150, 152 and/or 154 may be replaced with other suitable media, such as a bus or the like, and/or may be coupled via one or more other intermediary components (not shown) without departing from the present invention.

FIG. 3 is a diagram illustrating an embodiment of an operator input device 108. Operator input device 108 includes three buttons 302, 304 and 306. First color button 302 is configured to generate a signal that selects a first predefined color for light beam 134 (FIG. 1). Second color button 304 is configured to generate a second signal that selects a second predefined color for beam 134 (FIG. 1).

Accordingly, in one embodiment when a text region 130 (FIG. 1) is to be selected, actuation of the first color button 302 causes a first color of light to be generated as light beam 134 from light pen 106 (FIG. 1). That is, when image capture device 102 (FIG. 1) detects light of the first predefined color, the determined document portion is characterized as having text information that is to be scanned using a suitable resolution.

When an image region 132 (FIG. 1) is to be selected, actuation of the second color button 304 causes a second color of light to be generated as light beam 134 from light pen 106. That is, when image capture device 102 detects light of the second predefined color, the determined document portion is characterized as having image information that is to be scanned using a suitable resolution.

Any color for the first color and the second color may be selected so long as the color is discernable to the operator and to the image capture device 102. Thus, some care must be taken in defining the light colors so as not to have the same or similar light color as the color of (or on) scanned documents. However, an alternative embodiment allows the operator to redefine light colors when a light becomes difficult to discern and/or detect because of the color of the scanned document and/or ambient lighting conditions.

Selection completed button 306 is configured to generate a signal indicating that the operator has completed selecting portions of the document for scanning. This signal is communicated to the document transport device 126 (FIG. 1) to indicate that the document may be communicated to the scanning device 110 (FIG. 1) for scanning. Also, if there is another document to be processed by the operator, the next document is advanced to the viewing region 129.

In another embodiment, the selection completion button 306 may be double clicked, or the like, to indicate that the end of a document group has been processed by the operator. Thus, the next image is understood to be the first image of the next document group. Or, in an embodiment that employs other indicators identifying the last document of a document group, the document transport device understands that documents are to be advanced until the first document in the next document group is viewable by the operator. This feature is particularly advantageous when a document group having a large number of documents is being processed, and one or more of the last documents of the document group does not have any portions of interest.

Examples of buttons 302, 304 and 306 include, but are not limited to, a push-button, a toggle-switch, a multi-position sensing device configured to sense a plurality of switch positions, a touch sensitive device or a light sensitive device. In one embodiment, a single button is a multifunction controller configured to have one or more of the functionalities of buttons 302, 304 and/or 306. Furthermore, the functionality of buttons 302, 304 and/or 306 may be alternatively implemented as a menu displayed on display (not shown).

For convenience, the buttons 302, 304 and 306 were illustrated as text generally describing the functionality of the button. Alternatively, any suitable icon and/or label could be used on the buttons 302, 304 and 306 to indicate the functionality of the button. For example, but not limited to, a colored label corresponding to the color of the generated light beam 134 (FIG. 1) may be used to indicate the color of the light beam. (If a red colored light beam is used to select text portions, a corresponding button on the operator input device 108 (FIG. 1) could be colored red.) Thus, the operator only need remember the functionality of the scanning associated with the predefined color.

Similarly, any suitable symbol or text may be used to denote button functionality. For example, the text “scan text” or the like may be used to identify a button that causes light pen 106 (FIG. 1) to generate a colored light associated with text scanning. Or, the text “scan image” or the like may be used to identify a button that causes light pen 106 to generate another colored light associated with high resolution image scanning. Also, for example, a symbol resembling a page of paper or the like may be used to identify that the operator has completed selection of document portions. Furthermore, a predefined color, symbol and/or text may be combined on a button.

An above-described embodiment allows the operator to change the color of light generated by light pen 106 with respect to the characteristic of the determined document portion. For example, yellow light may be predefined to characterize document portions as having text information. However, yellow light would not work well when the document is made of yellow paper. Accordingly, one of a plurality of color buttons is selected by the operator to change light beam 134 (FIGS. 1, 2 and 4) to another color that is discernable and/or detectable on the yellow colored document. The operator selects a characterization button to indicate the scanned portion is text. (Or, the operator could specify the character of the document portion first, and then select a light color, in an alternative embodiment.) A similar process is used to change color for light associated with image information.

The above-described alternative embodiments of the control buttons on operator input device 108 (FIGS. 1 and 3) are intended as illustrative, non-limiting examples of imparting information indicating the functionality and/or operation of the document scanning system 100 (FIG. 1) to the operator. Accordingly, it is understood that the possible manners in which button functionality can be communicated to the operator is nearly limitless. All such variations are intended to be within the scope of this disclosure.

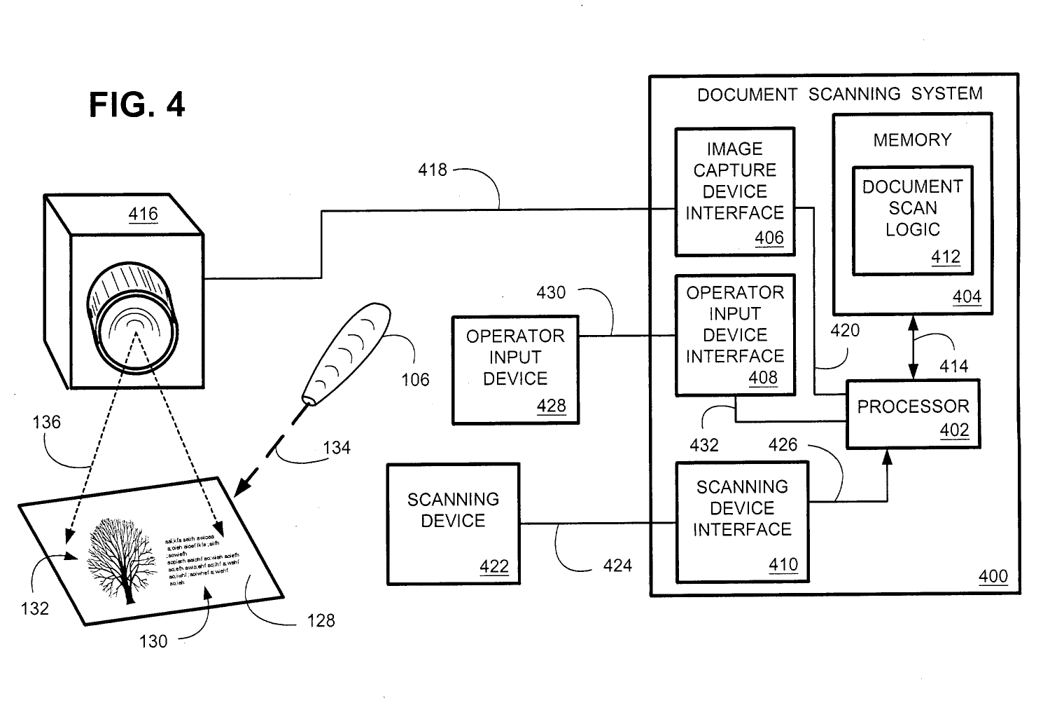

Also, for convenience, operator input device 108 is illustrated as a separate, stand-alone component. In an alternative embodiment, one or more of the buttons 302, 304 and 306 are included as an integral part of light pen 106 (FIGS. 1 and 4). For example, the color selection buttons 302 and 304 may be incorporated into the light pen 106, and the selection completed button 306 may reside at another convenient location.

FIG. 4 is a diagram illustrating an automated document scanning system 400 according to another embodiment of the present invention. Document scanning system includes processor 402, memory 404, image capture device interface 406, operator input device interface 408 and scanning device interface 410. Document scan logic 412, residing in memory 404, is retrieved and executed by processor 402, via connection 414.

Document scanning system 400 is configured to couple to an image capture device 416, via connection 418 and image capture device interface 406. Image capture device 416 may be any suitable digital image capture device, such as a digital still or video camera, so long as the image capture device 416 is configured to communicate with document scanning system 400. For example, but not limited to, image capture device 416 may be a commercially available digital camera using a standardized connection, such that connection 418 is coupled to image capture device 416 and image capture device interface 406.

Information generated by the image capture device 416, in accordance with the present invention, is received and processed by processor 402, via connection 420. Accordingly, one embodiment of the document scan logic 412 is configured to interpret received signals from image capture device 416. In another embodiment, information from image capture device 416 is interpreted by another software application (not shown). Thus, great flexibility may be achieved with this embodiment in that the document scanning system 400 may be configured to receive information from any variety of image capture device types, models and/or manufacturers.

Document scanning system 400 is further configured to couple to a scanning device 422, via connection 424 and scanning device interface 410. Scanning device 422 may be any suitable scanning device so long as the scanning device 422 is configured to receive information from document scanning system 400 identifying the location and/or character of selected document portions that are to be scanned. Information generated by processor 402 identifying selected document portions that are to be scanned (location and/or character), in accordance to the present invention, is communicated to scanning device 422, via connections 426. Accordingly, one embodiment of the document scan logic 412 is configured to generate information identifying selected document portions for a variety of scanning devices. Thus, great flexibility may be achieved with this embodiment in that the document scanning system 400 may be configured to communicate information to a variety of scanning device types, models and/or manufacturers.

Document scanning system 400 is further configured to couple to an operator input device 428, via connections 430/432 and operator input device interface 408. Operator input device 428 may be any suitable input device configured to generate and communicate information to document scanning system 400 identifying selected operation functions of the present invention. For example, but not limited to, operator input device 428 may be a keyboard device, a mouse device, or another input device allowing the operator of the document scanning system 400 to select the above-described operating functions. Accordingly, one embodiment of the document scan logic 412 is configured to receive and interpret instructions from the operator input device 428 before the document 128 is scanned. Thus, great flexibility may be achieved with this embodiment in that the document scanning system 400 may be configured to communicate information to a variety of operator input device types, models and/or manufacturers.

Thus, with this embodiment, the document 128 is placed is a convenient location such that the operator can use beam 134 to identify selected document portions that are to be scanned, and such that image capture device 416 can detect reflections from light beam 134 from the document 128.

FIG. 4 further illustrates another embodiment of the present invention. This embodiment is a software embodiment that is installed on a suitable personal computer (PC), network device, laptop, workstation or the like. Thus, suitable components can be configured in accordance with FIG. 4, and the document scan logic 412 downloaded into the processor system, thereby converting the processor system into a document scanning system 400.

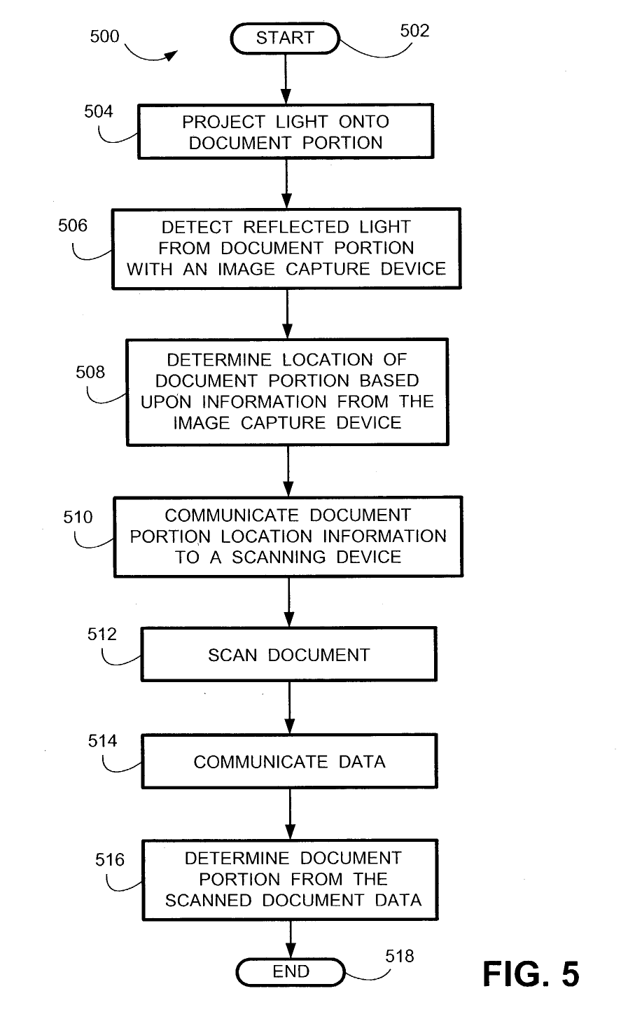

FIG. 5 is a flowchart 500 illustrating an embodiment of a process for determining and communicating location information of a document portion to a scanning device. The flow chart 500 shows the architecture, functionality, and operation of a possible implementation of the software for implementing the document scan logic 124 (FIG. 1) and/or the document scan logic 412 (FIG. 4). In this regard, each block may represent a module, segment, or portion of code, which comprises one or more executable instructions for implementing the specified logical function(s). It should also be noted that in some alternative implementations; the functions noted in the blocks may occur out of the order noted in FIG. 5 or may include additional functions without departing significantly from the functionality of the document scan logic 124 and/or the document scan logic 412. For example, two blocks shown in succession in FIG. 5 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure and to be protected by the accompanying claims.

The process starts at block 502. At block 504, light from light pen 106 (FIGS. 1 and 4) is projected onto a portion of the document that is to be scanned. At block 506, reflected light from the document portion is detected with image capture device 102 (FIG. 1) or image capture device 412 (FIG. 4). At block 508, the location of the document portion is determined based upon information from image capture device 102 or image capture device 412. At block 510, the document portion location information is communicated to a scanning device.

In one embodiment, at block 512, the document 128 is scanned. At block 514, the data corresponding to the scanned document is communicated to the processor system 104. At block 516, the document portion, identified by the path traveled by the light beam 134, is determined as described herein. The process ends at block 518. In another embodiment, the location of the identified document portion is communicated to a scanner and the identified document portion is scanned.

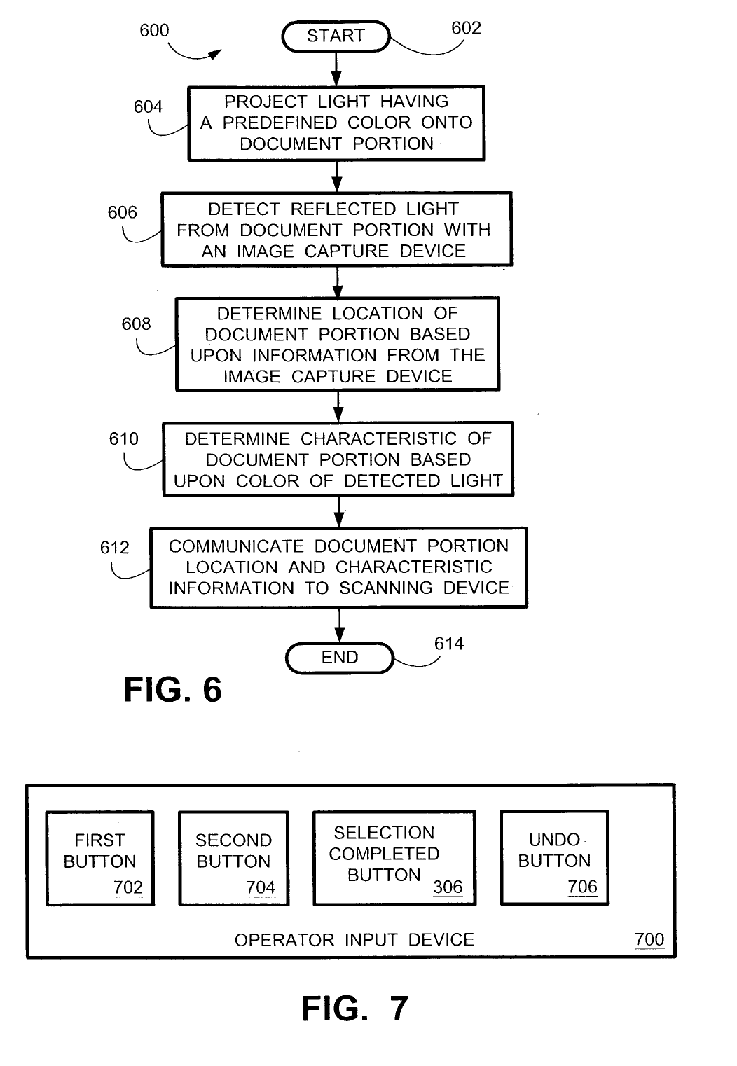

FIG. 6 is a flowchart 600 illustrating another embodiment of a process for determining and communicating location information and characteristics of a document portion to a scanning device. The flow chart 600 shows the architecture, functionality, and operation of a possible implementation of the software for implementing the document scan logic 124 (FIG. 1) and/or the document scan logic 412 (FIG. 4). In this regard, each block may represent a module, segment, or portion of code, which comprises one or more executable instructions for implementing the specified logical function(s). It should also be noted that in some alternative implementations, the functions noted in the blocks may occur out of the order noted in FIG. 6 or may include additional functions without departing significantly from the functionality of the document scan logic 124 and/or the document scan logic 412. For example, two blocks shown in succession in FIG. 6 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure and to be protected by the accompanying claims.

The process starts at block 602. At block 604, light from light pen 106 (FIGS. 1 and 4) having a predefined color is projected onto a portion of the document that is to be scanned. At block 606, reflected light from the document portion is detected with image capture device 102 (FIG. 1) or image capture device 412 (FIG. 4). At block 608, the location of the document portion is determined based upon information from digital camera 102 or digital camera 412. At block 610, a characteristic of the document portion is determined based upon color of the detected light. At block 612, the document portion location and characteristic information is communicated to a scanning device. The process ends at block 614. Optionally, the process may continue as described in blocks 512, 514 and 516 described above.

The above-described embodiments employ an image capture device 102 or 416 (FIGS. 1, 2 and/or 4) to detect reflected light from document 128 (FIGS. 1, 2 and/or 4). In one embodiment, image capture device 102 is a digital video camera. In another embodiment, image capture device 102 or 416 may be a digital still camera that periodically communicates detected light information at a suitable interval so that the location and/or characteristics of a selected document portion are determinable. As used herein, the term image capture device designates any suitable digitally based image capture device.

Image capture device 102 or 416 is a digital based image capture device configured to periodically communicate data corresponding to captured images of document 128. In one embodiment, the captured image data is communicated in a stream-like fashion as fast as a photo sensor residing in the image capture device 102 or 416 captures images. In another embodiment, the image capture device 102 or 416 is configured to periodically communicate captured image data at predefined time intervals. Such predefined time intervals are selected so that the selected portions of document 128, as identified by light from light pen 106, are determinable. That is, captured image data is provided with sufficient frequency so that the colored light reflecting from document 128 is discernable in a manner that allows the path of colored light travelling over document 128 to be determined.

In one embodiment, the image capture device 102 or 416 operates in an “always-on” mode of operation. That is, captured image data is streamed or periodically communicated without regard to the presence or absence of a document 128 in the viewing region represented by dashed lines 136. In another embodiment, an actuator is provided at a convenient location that actuates the image capture device 102 or 416 so that captured image data is streamed or periodically communicated. Such an embodiment employs a separate actuator or an actuator on the light pen 106, In another embodiment, actuation of the image capture device 102 or 416 is synchronized with the generation of colored light from the light pen 106.

In an alternative embodiment, a single color of light is used by the operator to locate document portions and document characteristics. Thus, light beam 134 (FIGS. 1, 2 and/or 4) is of a single color. The characteristics of the document portions are specified when the operator selects a button that defines the character of the identified document portion. FIG. 7 is a diagram illustrating an alternative embodiment of an operator input device 700. The operator actuates a first button 702 to specify a first characteristic and actuates a second button 704 to specify a second characteristic. It is understood that a button may be identified with any suitable icon and/or label to indicate the functionality of the button.

For example, the first button 702 may be defined to specify that the identified document portion is characterized by textual information. And, the second button 704 may be defined to specify that the identified document portion is characterized by image information.

The selection in one embodiment is made before the operator uses the light pen 106 (FIGS. 1, 2 and/or 4) to identify a document portion. In another embodiment, the selection is made after the operator uses the light pen 106 to identify a document portion.

In an alternative embodiment the functionality of the buttons is combined into a multi-function button, such as a toggle switch or the like, such that the characteristic of the image portion to be scanned is defined by the current position of the multi-function button. In yet another embodiment, the characteristic of the image portion to be scanned is specified by selection of the characteristic via a menu (not shown) on a display (not shown).

The above-described embodiments employ a light pen 106 (FIGS. 1, 2 and/or 4) to select a document portion using color. Accordingly, such a light pen 106 generates a light beam 134 (FIGS. 1, 2 and/or 4) using light from the visible spectrum. The light pen 106 may employ various light sources. For example, an incandescent light or other suitable visible light source with color filters are used in one embodiment. In another embodiment, one or more laser are configured to generate the different colors of light. Alternative embodiments employ a light pen 106 that generates a light beam 134 using light from other energy spectrums. For example, an ultraviolet light source may be used. When such a non-visible light source is employed, the operator may use a detector, such as specially configured glasses or a visor, that is sensitive to the light source used.

Furthermore, the above described embodiments employing a light pen 106 (FIGS. 1, 2 and/or 4) to select a document portion may be implemented using any suitable device that is conveniently hand-held by the operator and that generates light beam 134. Thus, the present invention is not intended to be limited by the shape, size or nature of the device generating light beam 134.

In yet another embodiment, a light pen 106 generates a light beam 134 of a single color that flashes on/off at different rates. The rate of flashing indicates the characteristic of the scanned document portion. Flashing rates may be invisible or visible to the operator, depending upon the embodiment.

Embodiments described herein may be further modified to specify an output destination for the scanned image portion. The output destination may be a specified memory, a specified file folder, and/or a specified file name. That is, this characteristic, a destination, can be specified by the color of the light. One such embodiment employs a light pen 106 (FIGS. 1, 2 and/or 4) configured to generate a light beam 134 of many different colors of light. Thus, the color of the light beam 134 is used to designate multiple characteristics of the selected document portion. For example, but not limited to, one color indicates that the selected document portion has textual information (thereby interpreted by an OCR algorithm and generated as a text string) and is to be saved in a first destination. A second color could indicate that the selected document portion has textual information and is to be saved in a second destination. Accordingly, it is understood that such an embodiment may be configured to define many multiple characteristics and/or characteristic combinations.

Alternatively, multiple characteristics associated with a selected document portion may also be specified using control buttons on an operator input device. Thus, additional buttons could be added to the operator input device 108 (FIG. 1) or the operator input device 700 (FIG. 7) to enable the operator to select characteristics for the selected document portion. Also, multiple characteristics of the image portion to be scanned may be specified by selection of the characteristic(s) via a menu (not shown) on a display (not shown).

Another feature is illustrated on the operator input device 700. This is an “undo” feature. Upon selection of undo button 706 by the operator, the most recently specified document portion is canceled. That is, information identifying that document portion is not communicated to the scanning device. Accordingly, that document portion is not scanned and/or saved as a selected document portion. For convenience of illustration, button 706 is labeled as an “undo button.” It is understood that button 706 may be identified with any suitable icon and/or label to indicate the above-described functionality of the button 706.

The above-described embodiments, for convenience, were described as using a color of light, or another means, to specify the characteristic of the specified document portion such that the scanning device scans the specified document portion at a predefined scanning resolution. For example, if the specified document portion has the characteristic of having textual information, that document portion is scanned at a resolution suitable for an OCR system such that a text string is generated. When the specified document portion has the characteristic of having image information, that document portion is scanned at a resolution suitable for scanning an image. In another embodiment, other scanning resolutions may be predefined and associated with a characteristic of a specified document portion. In another embodiment, a third resolution may be predefined and associated with a characteristic. In yet another embodiment, a third characteristic is defined that corresponds to color on the specified image portion. Accordingly, if the specified document portion is a color image, scanning at a high resolution with color may be predefined. Or, if the specified document portion has colored text, scanning at a resolution with color and suitable for an OCR system may be predefined.

The processors 110 (FIG. 1) and/or 402 (FIG. 4) are typically a commercially available processors. Examples of commercially available processors include, but are not limited to, a Pentium microprocessor from Intel Corporation, Power PC microprocessor, SPARC processor, PA-RISC processor or 68000 series microprocessor. Many other suitable processors are also available. Or, processors 110 or 402 may be a specially designed and fabricated processors in accordance with the present invention.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method identifying portions of a document to be scanned, the method comprising the steps of:
projecting a beam of light onto a document portion;
detecting reflected light from the document portion with an image capture device; and
determining a location of the document portion on the document based upon information received from the image capture device.

2. The method of claim 1, further comprising the steps of:
communicating the determined location to a scanning device; and
scanning at least the document portion identified by the location.

3. The method of claim 1, further comprising the steps of:
scanning the document;
communicating data corresponding to the scanned document; and
determining the document portion from the received data.

4. The method of claim 1, further comprising the steps of:
projecting the beam of light using a predefined color onto the document portion;
determining a characteristic of the document portion based upon the color of the detected reflected light; and
communicating the determined characteristic to the scanning device such that the scanning device scans at least the document portion at a resolution corresponding to the determined characteristic.

5. The method of claim 4, further comprising the steps of:
specifying the predefined color of the beam of light as a first color, the first color corresponding to the document portion having a characterization of textual information such that when the step of scanning is performed, a first scanning resolution suitable for scanning text is used; and
specifying the predefined color of the beam of light as a second color, the second color corresponding to the document portion having a characterization of image information such that when the at least the document portion is scanned, a second scanning resolution suitable for scanning images is used.

6. The method of claim 5, further comprising the steps of:
receiving information from the scanning device, the received information corresponding to the document portion;
converting the received information into text using an optical character resolution program; and
storing the text into a memory as a text string.

7. The method of claim 5, further comprising the step of specifying the predefined color of the beam of light as a third color, the third color corresponding to the document portion having a predefined characterization of containing color information such that when the step of scanning is performed, a third scanning resolution suitable for scanning a plurality of colors on the document portion is used.

8. The method of claim 1, further comprising the steps of:
receiving information from the scanning device, the received information corresponding to at least the document portion; and
storing the received information in a memory.

9. The method of claim 8, further comprising the steps of:
determining a characteristic of the determined document portion based upon a color of the detected reflected light;
associating the characteristic with a memory location; and
determining the memory location based upon the determined characteristic so that the step of storing the information into the memory stores the information into the determined memory location.

10. The method of claim 1, further comprising the step of receiving a signal corresponding to an end of the steps of projecting, detecting and determining such that the step of communicating communicates the determined locations for the plurality of document portions to the scanning device.

11. The method of claim 1, further comprising the steps of:
projecting a flashing beam of light onto the document portion using a selected flashing rate selected from a plurality of flashing rates;
determining a characteristic of the determined document portion based upon the selected flashing rate of the detected reflected light; and
communicating the determined characteristic to the scanning device such that the scanning device scans at least the document portion at a resolution corresponding to the determined characteristic.

12. A system which identifies portions of a document to be scanned, comprising:
a light pen configured to generate a beam of light;
an image capture device configured to detect reflected light from a document, the reflected light corresponding to the beam of light generated by the light pen;
an operator input device configured to select at least one characteristic associated with a selected document portion selected from the document;
a processor configured to receive information from the image capture device and the information from the operator input device such that a location of the selected document portion and a characteristic of the selected document portion are determined; and
a scanning device interface configured to couple to a scanning device, and further configured to communicate the determined location and characteristic of the selected document portion to the scanning device.

13. The system of claim 12, further comprising the scanning device configured to receive the determined location and characteristic of the selected document portion, and further configured to select a scanning resolution from a plurality of scanning resolutions, the selected scanning resolution corresponding to the characteristic, and further configured to scan at least the document portion with the selected scanning resolution.

14. The system of claim 12, further comprising a document transport device, the document transport device configured to communicate the document from a viewing region to the scanning device after the information from the image capture device is communicated to the processor.

15. The system of claim 12, further comprising a memory configured to receive and store information corresponding to the selected document portion scanned by the scanning device.

16. The system of claim 15, further comprising an optical character resolution (OCR) logic configured to receive information corresponding to the scanned selected document portion when the characteristic corresponds to textual information, configured to determine the textual information residing in the scanned selected document portion, and further configured to generate a text string corresponding to the determined textual information.

17. The system of claim 12, further comprising a video digital camera configured to capture and communicate a video image of sufficient duration so that at least the location of the selected document portion is determinable.

18. The system of claim 12, further comprising a still digital camera configured to sequentially capture a plurality of still images, such that information corresponding to the still images are periodically communicated so that at least the location of the selected document portion is determinable.

19. The system of claim 12, wherein the light pen configured to generate a plurality of different colored light beams, each one of the colors of the light beams corresponding to a predetermined characteristic that is associated with the selected document portion.

20. The system of claim 19, wherein the light pen is configured to generate the plurality of different colored light beams using a visible light spectrum.

21. The system of claim 19, wherein the light pen is configured to generate the plurality of different colored light beams using a laser light device.

22. The system of claim 12, wherein the light pen configured to generate the light beam with a plurality of flashing rates, each one of the flashing rates corresponding to a predetermined characteristic that is associated with the selected document portion.

23. A system for identifying portions of a document to be scanned, comprising:
means for projecting a beam of light onto a document portion, the beam of light having a color selected from a plurality of colors, each one of the plurality of colors uniquely associated with one of a plurality of characteristics;
means for detecting reflected light from the document portion with an image capture device;
means for determining a location of the document portion on the document based upon information received from the image capture device;
means for determining at least one characteristic based upon the color of the detected reflected light; and
means for communicating the determined location and characteristic to a scanning device such that the scanning device generates information corresponding to the document portion.

24. A computer-readable medium having a program for identifying portions of a document to be scanned, the program comprising logic configured to perform the steps of:
receiving information from an image capture device corresponding to detected reflected light from a document portion;
determining a location of the document portion on the document based upon information received from the image capture device;
determining at least one characteristic of the document portion based upon information corresponding to color of the detected reflected light; and
communicating the determined location and characteristic to a scanning device such that the scanning device generates information corresponding to the document portion.

25. A system which identifies portions of a document to be scanned, comprising:
an image capture device interface configured to couple to an image capture device, and further configured to receive information from the image capture device corresponding to detected reflected light from a document, the reflected light corresponding to light generated by a light pen;
an operator input device interface configured to couple to an operator input device, and further configured to receive information from the operator input device corresponding to at least one selected characteristic of a selected document portion selected from the document;
a processor configured to receive the information from the image capture device and the information from the operator input device such that a location of the selected document portion and the characteristic of the selected document portion are determined; and
a scanning device interface configured to couple to a scanning device, and further configured to communicate the determined location and the determined characteristic of the selected document portion to the scanning device.
